(19) United States
(12) Patent Application Publication
(10) Pub. No.: US 2009/0100435 A1
(43) Pub. Date: Apr. 16, 2009

(54) HIERARCHICAL RESERVATION RESOURCE SCHEDULING INFRASTRUCTURE

(75) Inventors: Efstathios Papaefstathiou, Redmond, WA (US); Sean E. Trowbridge, Sammamish, WA (US); Eric Dean Tribble, Bellevue, WA (US); Stanislav A. Oks, Kirkland, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/870,981

(22) Filed: Oct. 11, 2007

(51) Int. Cl. G06F 9/50

(52) U.S. Cl. 718/104

(57) ABSTRACT

Scheduling system resources. A system resource scheduling policy for scheduling operations within a workload is accessed. The policy is specified on a workload basis such that the policy is specific to the workload. System resources are reserved for the workload as specified by the policy. Reservations may be hierarchical in nature where workloads are also hierarchically arranged. Further, dispatching mechanisms for dispatching workloads to system resources may be implemented independent from policies. Feedback regarding system resource use may be used to determine policy selection for controlling dispatch mechanisms.

### BACKGROUND

### Background and Relevant Art

Computers and computing systems have affected nearly every aspect of modern living. Computers are generally involved in work, recreation, healthcare, transportation, entertainment, household management, etc. Many computers, including general purpose computers, such as home computers, business workstations, and other systems perform a variety of different operations. Operations may be grouped into workloads, where a workload defines a set of operations to accomplish a particular task or purpose. For example, one workload may be directed to implementing a media player application. A different workload may be directed to implementing a word processor application. Still other workloads may be directed to implementing calendaring, e-mail, or other management applications. As alluded to previously, a number of different workloads may be operating together on a system.

To allow workloads to operate together on a system, system resources should be properly scheduled and allocated to the different workloads. For example, one system resource includes a processor. The processor may have the capability to perform digital media decoding for the media player application, font hinting and other display functionality for the word processor application, and algorithmic computations for the personal management applications. However, the single-processor can typically only perform a single or limited number of tasks at any given time. Thus, a scheduling algorithm may schedule system resources, such as the processor, such that the system resources can be shared among the various workloads.

Typically, scheduling of system resources is performed using a general purpose algorithm for all workloads irrespective of the differing nature of the different workloads. In other words, for a given system, scheduling of system resources is performed using system-wide, workload agnostic policies.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes a method of scheduling system resources. The method includes assigning a system resource scheduling policy for a workload. The policy is for scheduling workload operations within a workload. The policy is specified on a workload basis such that the policy is specific to the workload. System resources are reserved for the workload as specified by the policy.

Another embodiment includes a method of executing workloads using system resources. The system resources have been reserved in reservations for workloads according to system specific policies, where the reservations are used by workloads to apply workload specific policies. The method includes selecting a policy. The policy is for scheduling workload operations within a workload. The policy is used to dispatch the workload to a system resource. Feedback is received including information about the uses of the system when executing the workload. Policy decisions are made based on the feedback for further dispatching workloads to the system resource.

In yet another embodiment, a method of executing workloads on a system resource is implemented. The method includes accessing one or more system resource scheduling policies for one or more workloads. The policies are for scheduling workload operations within a workload and are specified on a workload basis such that a given policy is specific to a given workload. An execution plan is formulated that denotes reservations of the system resource as specified by the policies. Workloads are dispatched to the system resource based on the execution plan.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a hierarchical workload and policy structure;

FIG. 2 illustrates an execution plan illustrating reservations of system resources;

FIG. 3 illustrates a resource management system and system resources;

FIG. 4 illustrates an example of processor management;

FIG. 5 illustrates a device resource manager;

FIG. 6 illustrates a method of reserving system resources;

FIG. 7 illustrates a method of managing system resources according to reservations; and

FIG. 8 illustrates an example environment where some embodiments may be implemented.

### DETAILED DESCRIPTION

Some embodiments herein may comprise a special purpose or general-purpose computer including various computer hardware, as discussed in greater detail below. Some embodiments may also include various method elements.

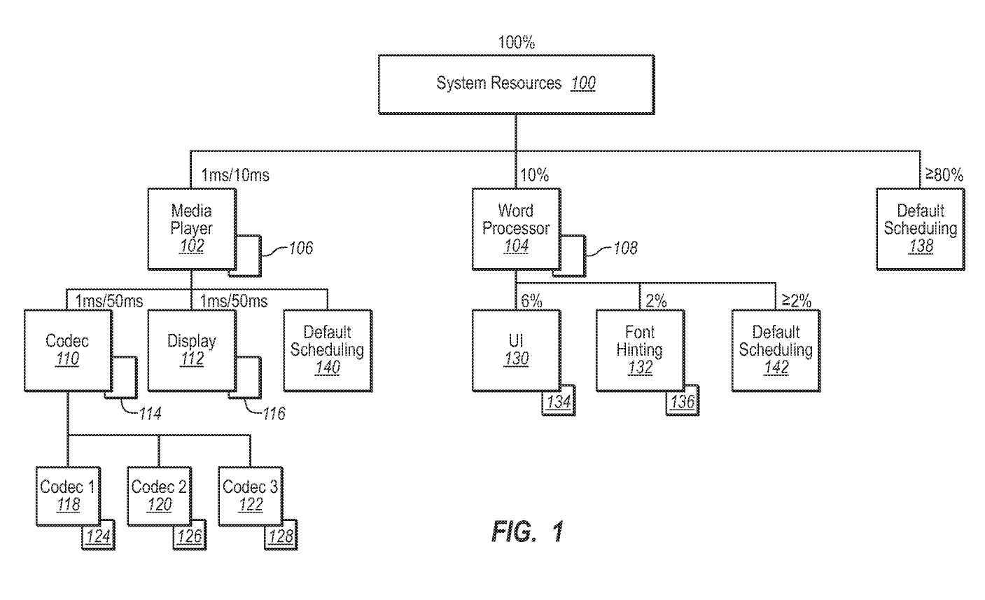

Embodiments may be implemented where policies for system resource reservation for workload operations are applied according to a policy particular to a workload. In other words, rather than resource reservation being performed according to a general, all-purpose policy applicable generally to all workloads scheduled with system resources, system resources are scheduled based on a policy specified specifically for a given workload. In addition, embodiments may be implemented where reservations for workloads may be accomplished according to hierarchically applicable policies. FIG. 1 illustrates example principles showing one embodiment implementing various features and aspects that may apply to some embodiments.

FIG. 1 illustrates system resources 100. System resources may include, for example, hardware such as processing resources, network adapter resources, memory resources, disk resources, etc. System resources can execute workloads. Workloads include the service requests generated by programs towards the system resources. For example workloads appropriate to processors include, for example, requests to perform processor computations. Workloads appropriate for network adapter resources include, for example, network transmit and receive operations, use of network bandwidth, etc. Workloads appropriate for memory resources include, for example, memory reads and writes. Workloads appropriate for disk resources include, for example, disk reads and writes.

Depending on context, workload may refer to request patterns generated by programs as a result of user or other program activities and might represent different levels of request granularity. For example an e-commerce workload might span multiple servers and implies a certain request resource pattern generated by the end users or other business functions.

Workloads may be defined in terms of execution objects. An execution object is an instance of workload abstraction that consumes resources. For example an execution object may be a thread that consumes processor and memory, a socket that consumes NIC bandwidth, a file descriptor that consumes disk bandwidth, etc.

System resources may be reserved for workloads. Two of the workloads illustrated in FIG. 1 include a media player workload 102 and a word processing workload 104. Each of these workloads define operations used in implementing media player and word processing applications respectively. FIG. 1 further illustrates that these two workloads each have a different policy 106 and 108 associated with them respectively. These policies define how the system resources 100 should be reserved for scheduling to execute the workloads 102 and 104.

Various policies may be implemented. For example, one policy is a rate based reservation policy. Rate reservations include recurring reservations in the form of a percentage of the system resource capacity at predetermined intervals. For example, a rate reservation policy may specify that a quantum of processor cycles should be reserved. For example a rate reservation policy may specify that 2,000 out of every 1,000,000 processor cycles should be allocated to a workload to which the policy applies. This type of reservation is often appropriate for interactive workloads. An example of this policy is illustrated for the media player workload 102, where the policy 106 specifies that 1 ms of every 10 ms should be reserved for the media player workload 102.

Another policy relates to capacity based reservations. Capacity reservations specify a percentage of the device's capacity without constraints for the timeframe that this capacity should be available. These types of policies may be more flexibly scheduled as the guarantee of the reservation has no timeframe. An example of this is illustrated for the word processor workload 104, where the policy 108 specifies 10% of the system resources 100 should be reserved for the word processor workload 104.

Notably, the policies 106 and 108 are particular to their respective applications meaning that the policies are specified for a particular application. Specifying for a particular application may be accomplished by specifically associating each application with a policy. In other embodiments, application types may be associated with a policy. Other groupings can also be implemented within the scope of embodiments disclosed herein.

As illustrated in FIG. 1, each reservation can be further divided into sub-reservations. Using reservation and sub-reservations a tree hierarchy of reservations and default policies can be created. Leaf nodes of the hierarchy include reservation policies. For example, FIG. 1 illustrates that hierarchically below the media player workload 102 are a codec workload 110 and a display workload 112. Associated with these workloads are policies 114 and 116 respectively. These policies 114 and 116 are hierarchically below the policy 106 for the media player workload 102. FIG. 1 further illustrates other hierarchically arranged workloads and policies. For example, codec workloads 118, 120 and 122 are hierarchically below the codec workload 110. Similarly, polices 124, 126, and 128 are hierarchically below policy 114. FIG. 1 also illustrates that workloads 130 and 132 are hierarchically below workload 104, and that policies 134 and 136 are hierarchically below policy 108.

FIG. 1 illustrates that policies, in this example, may specify reservations in terms of a capacity based reservation specifying a percentage of resources, such as is illustrated at the word processor workload 104 where 10% of the total system resources 100 is specified. As illustrated, this reservation of 10% of total system resources may be subdivided among hierarchically lower workloads, such as is illustrated in FIG. 1, where the policy 134 specifies that 6% of total system resources should be reserved for the UI workload 134 and the policy 136 specifies that 2% of total system resources should be reserved for the font hinting workload 132. FIG. 1 further illustrates that policy 106 specifies a rate based policy whereby the policy 106 specifies that 1 ms out of every 10 ms should be reserved for the media player workload 102.

Reservations may be made, in some embodiments, with two capacity threshold parameters, namely soft and hard. The soft parameter specifies higher or equal system resource requirements to the hard capacity. The soft value is a requested capacity for achieving the optimum performance. The hard value is the minimum reservation value required for the workload to operate. In some embodiments, a reservation management system will attempt to meet the soft capacity requirement, but if the soft capacity requirement cannot be met, the reservation management system will attempt to use the hard value instead. The reservation management system can reduce a reservation such as by reducing the amount resources reserved for operations. If there is no capacity in the device for the hard capacity value, in some embodiments, the reservation management system will not run the application.

In addition to thresholds, reservations may be associated with a reservation urgency. The reservation urgency is a metric that determines relevant priority for reservations. Reservation urgency is applicable when the system is overcommitted and the reservation management system can only allocate resources to a subset of the pending reservations. If a higher urgency reservation attempts to execute, the reservation management system notifies the application of the lower urgency reservation that it has to release its reservation. The notification escalates to the application termination if the reservation is not released. Note that the reservation urgency is not necessarily a preemption scheduling mechanism but rather may be an allocation priority that is applied when a new reservation is requested and resources are not available.

Any execution object that has no object specific policy reservation requirements may be scheduled using a default policy. FIG. 1 illustrates a number of default policies, including policies 138, 140, and 142. The reservation management system assigns all the timeslots not reserved with rate reservations to either capacity reservation or the default policy. The default policies for all devices may be the same across the system. This is done to simplify load balancing operations. Notably, default policies may include more than simply any remaining capacity. For example, while the policy 108 specifies a reservation of 10% and the policy 106 specifies a reservation of 10% based on a rate capacity, the default scheduling policy 138, absent any other reservations, will have at least 80% of system resources that can be scheduled. The available resources for the default policy 138 may be greater than 80% if it can be determined that one or both of the media player workload 102 or the word processor workload 104 do not require their full reservation and thus portions of the system resource reservations are returned back for use by the default scheduling policy 138.

A default reservation may be associated with a policy to handle the reminder of resource allocation. Similar to the root node each sub-reservation can include a default placing policy for execution objects that will operate in its context and have no further reservation requirements. For example, default policies 140 and 142 are used for sub-reservation default scheduling.

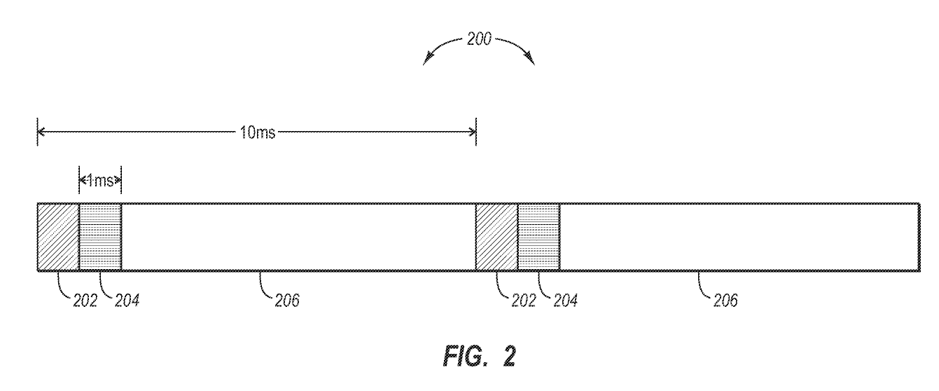

An execution plan is an abstraction used by resource management system components to capture information regarding reservations and device capacity. Specifically, an execution plan is a low-level plan that represents the resource reservations that will be acted on by a dispatcher. An example execution plan is illustrated in FIG. 2. The execution plan 200 illustrates the scheduling of system resources as specified by reservations. The illustrated execution plan 200 is a time based execution plan for system resources such as processors. While in this example, a time based execution plan is illustrated, it should be appreciated that for other devices, different execution plans may be implemented. For example, an execution plan for network devices may be represented in a sequence of packets that will be sent over a communication path. Other examples include slices of the heap for memory, blocks for disks, etc. Returning now to the time based example, the execution plan is a sequence of time slices that will be managed by the individual policy responsible for consuming the time slice. The policy that owns the reservation time slice can use quanta to further time-slice the reservation to finer grained intervals to multiplex between the execution objects that it manages. The granularity of a slice depends on the context of a device, for example the processor may depend on the timer resolution, NIC on packet size, memory on heap size, disks on blocks, etc.

The execution plan 200 illustrates a first reservation 202 for the media player workload 102 and a second reservation 204 for the word processor workload 104. The execution plan 200, in the example illustrated, illustrates time periods of resources that are reserved for a particular workload. While in this example, the reservations 202 and 204 are shown reoccurring in a period fashion, other allocations may also be implemented depending on the policy used to schedule the reservation. For example, the reservation 202 should be more periodic in nature, because of the requirement that 1 ms of every 10 ms be reserved for the media player workload 102. However, the reservation 204 may have more flexibility as the policy for scheduling the workload simply specifies 10% of system resources.

An execution plan may be used for several functions. In one example, an execution plan may be used to assess if enough device capacity is available for a new reservation. For example the execution plan 200 includes an indication 206 of available system resources on a time basis. When a request for a reservation is received, this indication 206 can be consulted to determine if the reservation request can be serviced.

The execution plan may also be used to assess if an interval is available to meet a rate reservation requirement. A device might have enough capacity to meet a reservation requirement but the appropriate slot might not be available for meeting the frequency and duration of the reservation if it is competing with an existing rate reservation.

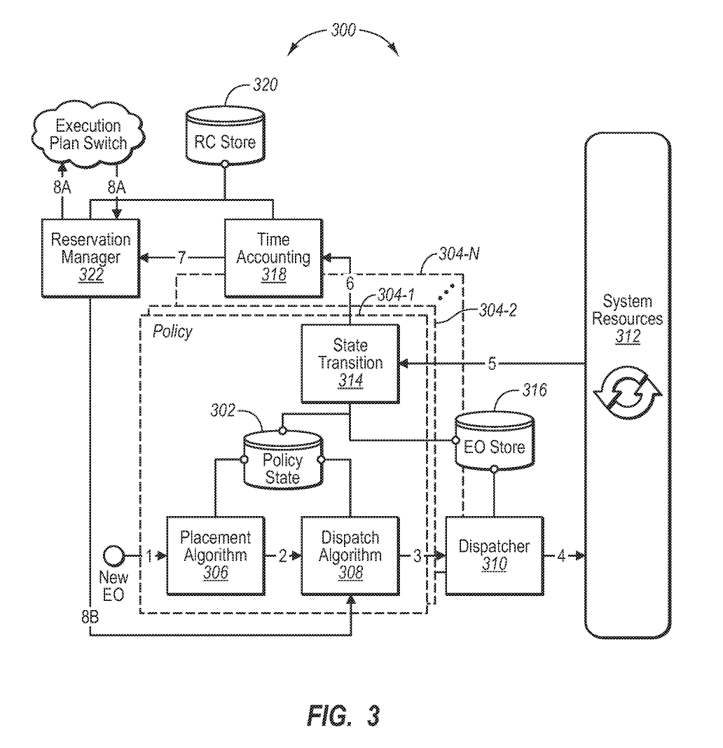

The execution plan may also be used to create a sequence of operations that a reservation manager can efficiently walk through to select the context of a new policy. This will be discussed in more detail below in conjunction with the description of FIG. 3.

The calculation of the execution plan is often an expensive operation that takes place when a new reservation is assigned to a device or a reservation configuration changes. In one embodiment, the plan is calculated by a device resource manager.

Reservations use a capacity metric that is specific to a type of a device. This metric should be independent of the resources and operating system configuration. However, the operating system may provide information about the capacity of the device.

Capacity reservations can either be scheduled statically as part of the execution plan, or dynamically as allocated time slices by the reservation manager. Static reservations may include for example assigning pre-assigning divisions of the resources, as opposed to dynamic evaluation and assignment of resources. The static allocation has the advantage of lowering the performance overhead of the resource manager. The dynamic allocation provides higher flexibility for dealing with loads running in the default policy of the same level of the scheduling hierarchy.

Referring now to FIG. 3, a reservation management architecture system 300 is illustrated. The scheduling hierarchy described previously may be a common scheduling paradigm that would be followed for all devices. However the depth and breadth of the hierarchy, and the policy complexity, will vary from device to device.

The components of the reservation management architecture system 300 are organized into two categories: stores and procedures. The components are either specific to a policy, a device type, or global. In FIG. 3, the policy components are grouped together. All other procedures are specific to a device type. The stores, with exception of the policy state store 302, are common to all devices of the system. The following sequence of operations is executed in a typical scheduling session starting with the introduction of a new execution object into the reservation management system 300.

As illustrated at 1, a new execution object is introduced into the reservation management system 300 according to a policy 304-1. A placement algorithm 306 moves the execution object into one of the queues stored in the policy state store 302. The policy state store 302 stores the internal state of the policy including queues that might represent priorities or states of execution.

As illustrated at 2, the placement algorithm 306 calls the policy dispatch algorithm 308 that will pick the next execution object for execution.

At 3, the device dispatcher 310 is called to context switch to the execution object selected for execution. The dispatcher 310 is implemented separate and independent from the policy 304-1 or any of the policies 304-1 through 304-N. In particular, the dispatcher 310 may be used regardless of the policy applied.

At 4, dispatcher 310 of the reservation management system 300 causes the system resources 312 to run the execution object. Notably, the system resources 312 may be separate from the reservation management system 300. Depending on the context of the device, the execution object execution will be suspended or completed. For example in a processor example, the allocated time slice for a processor expires, the execution object is waiting and blocked, or the execution object is voluntarily yielded.

As illustrated at 5, the policy state transition procedure 314 is invoked and the execution object state is updated in the execution object store 316 and the policy state store 302.

As illustrated at 6, the time accounting procedure 318 updates the usage statistics of the execution object using the resource container store 320. The resource container is an abstraction that logically contains the system resources used by a workload to achieve a task. For example a resource container can be defined for all of the components of a hosted application. The resource container stores accounting information regarding the use of resources by the application.

At 7, the reservation manager 322 will determine what is the next reservation and invokes the appropriate scheduler component to execute the next policy. This is achieved, in one embodiment, by walking through an execution plan such as the execution plan illustrated in FIG. 2. In the example shown in FIG. 3, there are two potential outcomes of this operation. The first is that a slice, such as one of the time slices illustrated in FIG. 2, or another slice such as packet slice, heap slice, block slice, etc. as appropriate, is assigned in the current policy of the current level of scheduling hierarchy. The dispatch algorithm 308 of the current policy will be called as shown as 8B in FIG. 3. The second outcome includes a switch to another reservation using a different policy such as the policy 304-2 or any other policy up to 304-N, where N is the number of policies represented. The reservation manager 322 switches to the execution plan of the new reservation (shown as 8A in the diagram) and performs the same operation with the new plan.

The overall execution object store 316 may not be accessible from a scheduling policy (e.g. 304-1) but rather a view of the execution objects that are currently managed by the policy is visible. In addition to potential performance gains this guarantees that policies will not attempt to modify the state of execution objects that are not scheduled in their context. Load balancing operations between devices can be achieved by moving execution objects between reservations running on different devices. The state transition procedure 314 and dispatcher procedure 310 can detect inconsistencies between the policy state store 302 and the execution object store 316 and take corrective action which in most cases involves executing an additional scheduling operation.

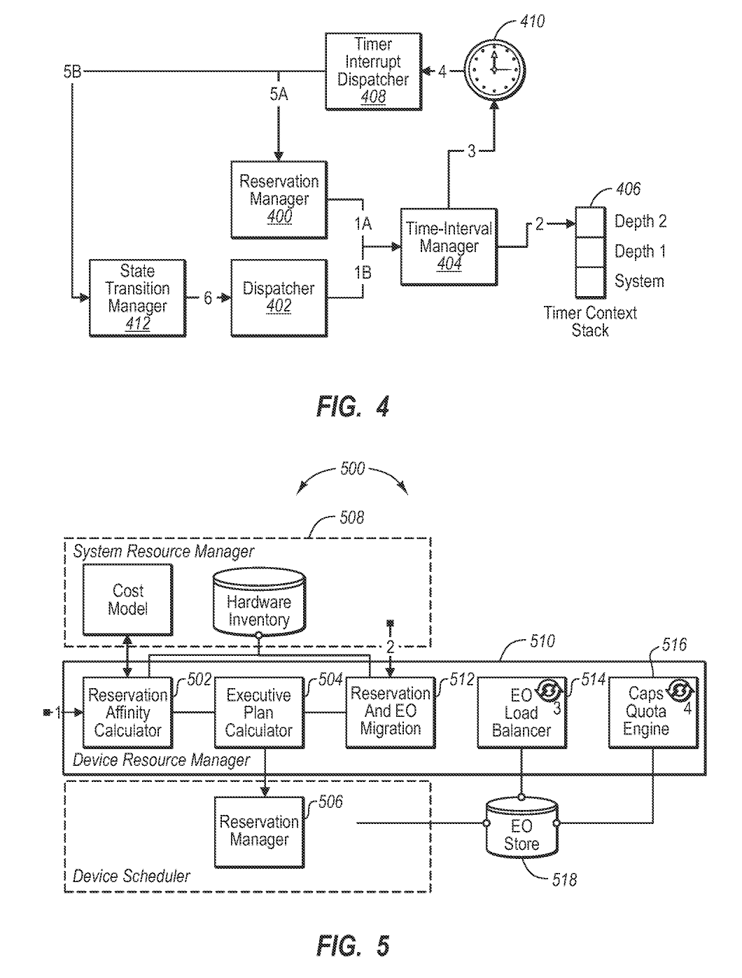

Referring now to FIG. 4, a potential implementation of a processor scheduler is illustrated. Notably, other implementations as well as other implementations for different systems resources, such as network resources, memory resources, disk resources, etc., may be implemented. In the scheduling framework proposed in FIG. 4, a processor is scheduled by multiple scheduling policies coordinated by a common infrastructure. The processor scheduler components that are provided by the infrastructure and the ones provided by policy are shown in FIG. 4. In the context of the processor the following are functions that are implemented: timer support, context switching, and blocking notification.

The processor scheduler components should be able to define an arbitrary duration timer interrupt (as opposed to a fixed quantum). The context of the timer interrupt can be either a reservation or further subdivision of a reservation from the policy that serves the reservation. For example, a priority-based policy might define fixed quantums within the context of the current reservation. At a particular moment, multiple timer deadlines exist and a processor scheduler component should be able to manage the various timer interrupts by specifying the next deadline, setting the context, and calling the appropriate scheduler component to serve the interrupt. The timer interval manager 404 maintains a stack of scheduler time contexts and schedules the timer interrupt using the next closest time-slice in the stack. The timer context includes a number of pieces of information. For example, the timer context includes information related to the type of context. This specifically refers to a reservation or execution object time-slice defined by the scheduling policy. The timer context includes information related to the time interval that the timer interrupt will fire. The timer context includes a pointer to either the current reservation manager 400, for reservations, or state transition manager 412, for scheduling policy. The timer context includes a pointer to a current execution plan for reservations.

The timer interrupt dispatcher 408 is triggered by the timer interrupt and depending on the preemption type and timer context it calls the scheduling entry point of a scheduling function. If the time-slice has expired for an execution object or the execution object is blocked, the current state transition manager is called and eventually the next execution object is scheduled within the reservation context. If the time-slice expired for a reservation, the reservation manager is called with the current execution plan context to choose the next reservation and policy.

FIG. 4 shows the typical control flow of the processor scheduler components. As illustrated in the case of a new reservation at 1A, the reservation manager 400 creates a new timer context object that includes the reservation time interval, a pointer to its own callback entry point, and a reference to the current execution plan. In the case of execution object scheduling at 1B, the dispatcher 402 creates the context with the execution object time interval and a pointer to the state transition manager callback function. As illustrated at 2, the time interval manager 404 pushes onto the timer context stack 406 the context of the request. At 3, the time interval manager 404 finds the closest time-slice, sets the context for the timer interrupt dispatcher 408 and programs the timer 410. At 4, the timer interrupt from the timer 410 fires and invokes the timer interrupt dispatcher 408. At 5, the timer interrupt dispatcher 408 examines its context and calls the reservation manager 400 callback function if a reservation expired or the state transition manager 412 if an execution object time-slice expired. At 6, after the state transition manager 412 is called, the execution object scheduling control flow is executed and the dispatcher 402 is called for another iteration in the process.

Previously, the description has focused on the design of a scheduling infrastructure of a single device. However, embodiments may include functionality whereby multiple devices are managed by a device resource manager. This may be especially useful given the recent prevalence of multi-core devices using multiple shared processors and hypervisor technologies using multiple operating systems.

In one embodiment, a device resource manager is responsible for performing tasks across the same type devices. Operations such as assignment of reservations to devices, load balancing, and load migration are typical operations performed by the device resource manager. In some embodiments, this may be accomplished by modifying execution plans for different devices and may include moving reservations from one execution plan to another. The device resource manager is a component invoked at relatively low frequency compared to the components of the device scheduler. As such it can perform operations that are relatively expensive.

The operations performed by device resource manager may, in some embodiments, fall into four categories that will now be discussed. The first is the assignment of reservations to devices and the creation of execution plans for device schedulers. The reservation assignment takes place when a new reservation is requested by an application or a reservation configuration takes place. The device resource manager initially inspects the available capacity of devices and allocates the reservation to a device. In addition to capacity there are other potential considerations, such as device power state, that might prevent the execution of certain workloads, and performance. The device resource manager is responsible for applying the reservation urgency policy. This is applicable in the case when no resources are available for a reservation. The reservation urgency of the new reservation is compared with existing reservation(s) and the device resource manager notifies application(s) with lower urgency reservation to retract their reservation or terminates them if they do not comply within a certain timeframe. Quotas are a special kind of policy. Quotas are static system-enforced policies that aim to limit the resource usage of a workload. Two particular types of quotas include caps and accruals. Caps act as thresholds that restrict the utilization of a resource to a certain limit. For example an application might have a cap of 10% of the processor capacity. Accruals are limits of the aggregate use of a resource over longer periods of times. For example one accrual may specify that a hosted web site should not use more than 5 GB of network bandwidth over a billing period. The same notification used in accrual quotas can be applied in the case of reservation preemption. Reservation requests that are not executed due to lack of resources and low relevant urgency can be queued and allocated when resources are freed.

After the allocation of the reservation has been determined the device resource manager will have to recalculate the execution plan for the device. In some embodiments, only recalculation of the root execution plan of the device scheduling hierarchy is necessary. The device resource manager also provides execution plan calculation services to schedulers that need to subdivide first-order reservations in other than the root levels of the device scheduling hierarchy.

The device resource manager should also be able to support gang scheduling where the same reservation should take place in multiple devices with the same start time. This feature is particularly useful for concurrency run-times that might require concurrent execution of threads that might require synchronization. By executing all threads on different devices at the same time, the coordination cost are minimized as all of them will be running when the synchronization takes place.

The device resource manager is also responsible for load balancing execution objects that run in the default scheduling policy for the root node of the device scheduling hierarchy. The operation involves moving execution objects between execution plans by moving the execution objects between the policy state stores of different devices. This is achieved by modifying the execution object view of the devices involved in the operation. The decision for load balancing could involve heuristics in operating systems such as latency considerations.

The device resource manager monitors the system resources and applies the caps quota thresholds. This is an operation that requires the cooperation of a device resource manager with a policy dispatcher. The device resource manager suspends execution objects for predefined periods by removing execution objects from the execution object view presented to the policy.

In the present example, the device resource manager uses an operating system service to enumerate devices, inspect device configurations, determine capacity and availability. The services used by the operating system for the device resource manager to operate are organized into a component referred to herein as a system resource manager. The device resource manager subscribes to the system resource manager event notification system for hardware failure, hot swap, etc. that require special operations regarding initiation and termination of device schedulers and load balancing operations.

FIG. 5 shows the components of a management system 500. The device resource manager 510, in this example, performs four notable operations. The first includes an execution plan calculation. For a new reservation, as illustrated at 1, the affinity calculator 502 selects the appropriate device on which the reservation will be executed. The reservation affinity calculator 502 calls the execution plan calculator 504 to derive a new execution plan for the device, which is then passed to the reservation manager 506 of the selected device. In the case of the reservation configuration change or subdivision of an existing reservation the affinity calculation is skipped.

The second operation relates to hardware changes. As illustrated at 2, the software resource manager 508 notifies the device resource manager 510, through the reservation and execution object migration procedure 512 that a change has taken place. The device resource manager 510 then migrates the reservations and execution objects currently assigned to a device, depending on the hardware change. For example if a device is about to move to low power mode the execution objects and reservations may be reallocated to other devices. The execution plan calculator 504 will be called to recalculate the execution plans of the affected devices.

The third operation relates to load balancing. As illustrated at 3, the execution object load balancer 514 reallocates execution objects running with the default policy at the root device scheduling hierarchy by modifying the execution object views of the involved devices.

A fourth operation relates to caps quota enforcement. As illustrated at 4, the caps quota engine 516 determines if the execution object has exceeded its threshold. If a violation is detected the state of the execution object is modified in the execution object store 518. The execution object is suspended for a predetermined amount of time by removing the execution object from the execution object view of the policy. The caps quota engine 516 will reestablish the execution object in the policy view. If the execution object is currently executing, the caps quota engine 516 flags the execution object and the view change takes place by a policy time accounting component.

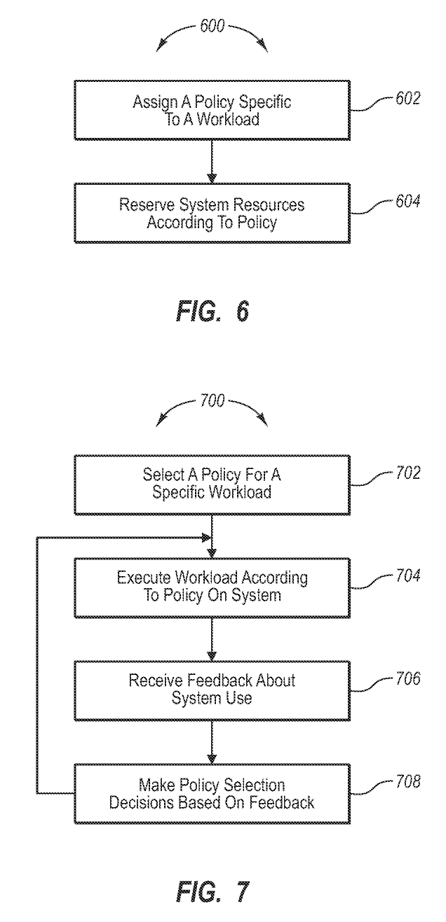

Referring now to FIG. 6, a method 600 is illustrated. The method 600 may include acts for scheduling system resources. The method includes accessing a system resource scheduling policy for a workload (act 602). The policy is for scheduling operations of a workload and is specified on a workload basis such that the policy is specific to the workload. For example, as illustrated among the many examples in FIG. 1, the policy 106 is specific to the workload 102. In one embodiment, a workload may use system policies to schedule reservations for the workload based on the workload specific policies used for executing the workload.

The method 600 further includes an act of reserving system resources for the workload as specified by the policy (act 604). An example of this is illustrated in the execution plan 200 where reservations 202 and 204 are implemented for workload specific policies.

The method 600 may further include reserving at least a portion of remaining unscheduled system resources for other workloads using a system default scheduling policy. FIG. 2 illustrates a reservation using system default scheduling policy at 206.

In some embodiments of the method of 600, the workload is hierarchically below another workload. For example, FIG. 1 illustrates, among other examples, workloads 110 and 112 hierarchically below workload 102. In one embodiment, reserving system resources for the workload (act 604) is performed as specified by both the policy for the workload and a policy for the workload hierarchically above the workload. Illustratively, reservations for the workload 110 may be scheduled based on both the policy 114 and the policy 106.

The policies may be specified in terms of a number of different parameters. For example, a policy may specify reservation of resources by rate, reservation of resources by capacity, or specify reservation of resources by deadline.

In one embodiment, reserving system resources for the workload as specified by the policy (act 604) includes consulting execution plans for a number of system resources where each of the system resources from among the number of system resources includes the same device type. For example, a system may include a number of different processors. Based on the execution plans, reserving system resources is performed in a fashion directed at load balancing the workloads among the plurality of system resources. In alternative embodiments, reserving system resources is performed in a fashion directed at migrating workloads from one device to another device. For example, if a device is to be removed from a system, or a device moves to a low power state with less capacity, or for other reasons, it may be desirable to move workloads from such a device to another device with available capacity. In another alternative embodiment, reserving system resources is performed in a fashion directed at enforcing caps quotas.

Referring now to FIG. 7, another method 700 embodiment is illustrated. The method 700 may be practiced, for example, in a computing environment. The method includes acts for executing workloads using system resources. The system resources have been reserved for workloads according to system specific policies. The policies are for scheduling operations of workloads. The method includes selecting a policy, where the policy is specific to a workload (act 702), using the policy to dispatch the workload to a system resource to execute the workload according to the policy (act 704), receiving feedback including information about the uses of the system when executing the workload (act 706), and making policy decisions based on the feedback for further dispatching workloads to the system resource (act 708). An example of this is illustrated in FIG. 3 which illustrates how policies 304-1 through 304-N are used in conjunction with a dispatchers 310 to cause workloads to be executed by system resources 312.

In the method 700, making policy decisions (act 708) may be based on an execution plan. The execution plan defines reservations of system resources for workloads. For example, after a workload has been executed on system resources 312, an execution plans such as execution planned 200 can be consulted to determine if policy changes should be made based on the amount of time the workload was executed on the system resources 312 as compared to a reservation such as one of the reservations 202 and 204.

Some of the embodiments described herein may provide one or more advantages over previously implemented scheduling systems. For example, some embodiments allow for specialization. In particular system resource scheduling should be customizable to meet workload requirements. A single scheduling policy may not able to meet all workload requirements. In some embodiments herein, a workload has the option to use default policies or define new scheduling policies specifically designed for the application.

Some embodiments allow for extensibility. Using embodiments described herein, scheduling policy may be extendable to capture workload requirements. This attribute allows for the desirable implementation of specialization. In addition to the default system supplied policies the resource management infrastructure can provide a pluggable policy architecture so workloads can specify their policies, not merely select from preexisting policies.

Some embodiments allow for consistency. The same resource management infrastructure can be used for different resources. Scheduling algorithms are typically specialized to meet the requirements of a device type. The processor, network, and disk schedulers might use different algorithms and might be implemented in different parts of the operating system. However in some embodiments, all schedulers may use the same model for characterizing components and the same accounting and quota infrastructure.

Some embodiments allow for predictability. The responsiveness of a subset of the workload may be independent of the load of the system and the scheduling policies. The operating system should be able to guarantee a predefined part of the system resources to applications sensitive to latencies.

Some embodiments allow for adaptability. Scheduling policies can be modified to capture the dynamic behavior of the system. The pluggable model for scheduling policies allows high-level system components and applications to adjust policies to tune their system performance.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

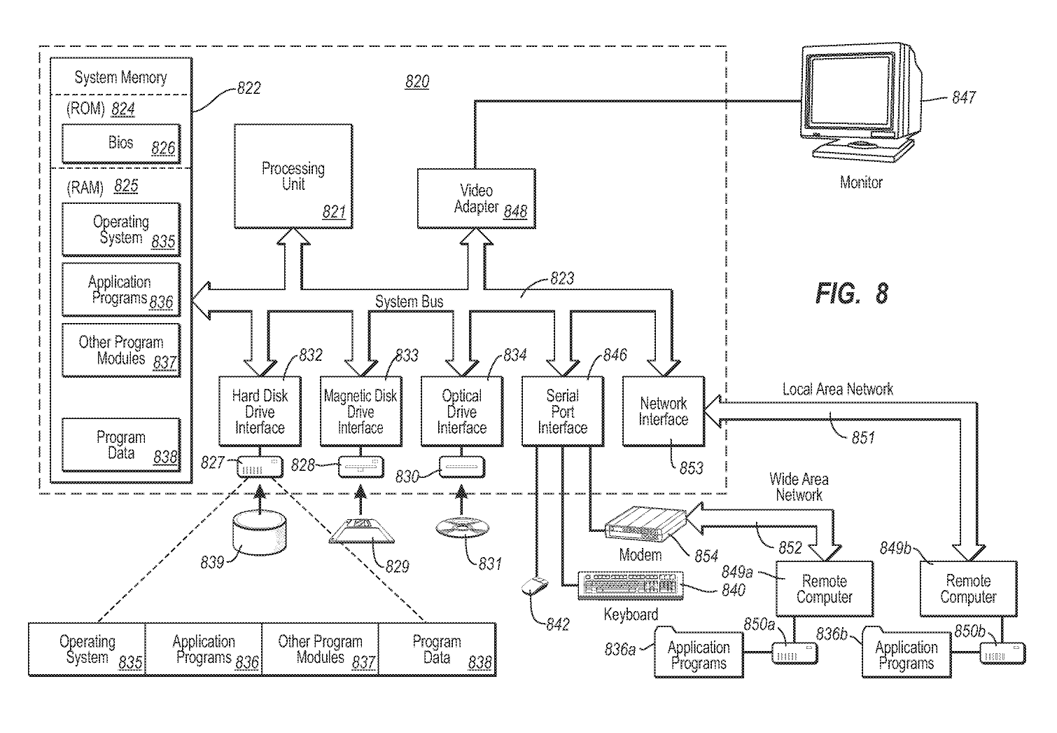

FIG. 8 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 8, an exemplary system for implementing the invention includes a general purpose computing device in the form of a computer 820, including a processing unit 821, which may include a number of processor as illustrated, a system memory 822, and a system bus 823 that couples various system components including the system memory 822 to the processing unit 821. The system bus 823 may be any of several types of bus structures including a memory bus or memory controller, a peripheral bus, and a local bus using any of a variety of bus architectures. The system memory includes read only memory (ROM) 824 and random access memory (RAM) 825. A basic input/output system (BIOS) 826, containing the basic routines that help transfer information between elements within the computer 820, such as during start-up, may be stored in ROM 824.

The computer 820 may also include a magnetic hard disk drive 827 for reading from and writing to a magnetic hard disk 839, a magnetic disk drive 828 for reading from or writing to a removable magnetic disk 829, and an optical disc drive 830 for reading from or writing to removable optical disc 831 such as a CD-ROM or other optical media. The magnetic hard disk drive 827, magnetic disk drive 828, and optical disc drive 830 are connected to the system bus 823 by a hard disk drive interface 832, a magnetic disk drive-interface 833, and an optical drive interface 834, respectively. The drives and their associated computer-readable media provide nonvolatile storage of computer-executable instructions, data structures, program modules and other data for the computer 820. Although the exemplary environment described herein employs a magnetic hard disk 839, a removable magnetic disk 829 and a removable optical disc 831, other types of computer readable media for storing data can be used, including magnetic cassettes, flash memory cards, digital versatile discs, Bernoulli cartridges, RAMs, ROMs, and the like.

Program code means comprising one or more program modules may be stored on the magnetic hard disk 839, removable magnetic disk 829, removable optical disc 831, ROM 824 or RAM 825, including an operating system 835, one or more application programs 836, other program modules 837, and program data 838. A user may enter commands and information into the computer 820 through keyboard 840, pointing device 842, or other input devices (not shown), such as a microphone, joy stick, game pad, satellite dish, scanner, or the like. These and other input devices are often connected to the processing unit 821 through a serial port interface 846 coupled to system bus 823. Alternatively, the input devices may be connected by other interfaces, such as a parallel port, a game port or a universal serial bus (USB). A monitor 847 or another display device is also connected to system bus 823 via an interface, such as video adapter 848. In addition to the monitor, personal computers typically include other peripheral output devices (not shown), such as speakers and printers.

The computer 820 may operate in a networked environment using logical connections to one or more remote computers, such as remote computers 849a and 849b. Remote computers 849a and 849b may each be another personal computer, a server, a router, a network PC, a peer device or other common network node, and typically include many or all of the elements described above relative to the computer 820, although only memory storage devices 850a and 850b and their associated application programs 36a and 36b have been illustrated in FIG. 8. The logical connections depicted in FIG. 8 include a local area network (LAN) 851 and a wide area network (WAN) 852 that are presented here by way of example and not limitation. Such networking environments are commonplace in office-wide or enterprise-wide computer networks, intranets and the Internet.

When used in a LAN networking environment, the computer 820 is connected to the local network 851 through a network interface or adapter 853. When used in a WAN networking environment, the computer 820 may include a modem 854, a wireless link, or other means for establishing communications over the wide area network 852, such as the Internet. The modem 854, which may be internal or external, is connected to the system bus 823 via the serial port interface 846. In a networked environment, program modules depicted relative to the computer 820, or portions thereof, may be stored in the remote memory storage device. It will be appreciated that the network connections shown are exemplary and other means of establishing communications over wide area network 852 may be used.

Embodiments may include functionality for processing workloads for the resources discussed above. The processing may be accomplished using a workload specific policy as described previously herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of scheduling system resources, the method comprising:
assigning a system resource scheduling policy the policy for scheduling operations within a workload, the policy being specified on a workload basis such that the policy is specific to the workload; and
reserving system resources for the workload as specified by the policy.

2. The method of claim 1, further comprising reserving at least a portion of remaining unscheduled system resources for other workloads using a system default scheduling policy.

3. The method of claim 1, wherein the workload is hierarchically below another workload and wherein reserving system resources for the workload is performed as specified by both the policy for the workload and a policy for the another workload hierarchically above the workload.

4. The method of claim 1, wherein the policy is at least one of specifying reservation of resources by rate; reservation of resources by capacity, or specifying reservation of resources by deadline.

5. The method of claim 1, wherein the system resources is at least one of a processor, network resources, memory resources or a disk resources.

6. The method of claim 1, wherein reserving system resources for the workload as specified by the policy comprises:
consulting execution plans for a plurality of system resources where each of the system resources from among the plurality of system resources comprises the same device type; and
based on the execution plans, reserving system resources in a fashion directed at load balancing the workloads among the plurality of system resources.

7. The method of claim 1, wherein reserving system resources for the workload as specified by the policy comprises:
consulting execution plans for a plurality of system resources where each of the system resources from among the plurality of system resources comprises the same device type; and
based on the execution plans, reserving system resources in a fashion directed at migrating workloads from one device to another device.

8. The method of claim 1, wherein reserving system resources for the workload as specified by the policy comprises:
consulting execution plans for a plurality of system resources where each of the system resources from among the plurality of system resources comprises the same device type; and
based on the execution plans, reserving system resources in a fashion directed at enforcing caps quotas.

9. In a computing environment, a method of executing workloads using system resources, wherein the system resources have been reserved for workloads according to system specific policies, and wherein the reservation is used by workloads to apply workload specific polices, the method comprising:
(a) selecting a policy, the policy being for scheduling operations within a workload;
(b) using the policy to dispatch the workload to a system resource;
(c) receiving feedback including information about the uses of the system when executing the workload; and
(d) making policy decisions based on the feedback for further dispatching workloads to the system resource.

10. The method of claim 9, further comprising repeating acts (b)-(d) to execute a plurality of workloads according to different policies specified for the workloads.

11. The method of claim 9, wherein making policy decisions is based on an execution plan, the execution plan defining reservations of system resources for workloads.

12. The method of claim 11, further comprising formulating the execution plan to denote one or more capacity based reservations.

13. The method of claim 1 1, further comprising formulating the execution plan to denote one or more rate based reservations.

14. The method of claim 9, wherein the system resource is one or more of a processor, network resources, memory resources, or disk resources.

15. The method of claim 9, wherein using the policy to dispatch the workload to a system resource comprises:
receiving at a dispatcher implemented separate from the policy, such that the dispatcher operates independent of any particular policy, information from the policy indicating a workload to be executed by the system resources; and
the dispatcher selecting the workload and causing the system resources to execute the workload.

16. The method of claim 9, wherein making policy decisions based on the feedback for further dispatching workloads to the system resource comprises at least one of selecting a new policy or the same policy based on the feedback.

17. In a computing environment, a method of executing workloads on a system resource, the method comprising:
accessing one or more system resource scheduling policies, the policies for scheduling operations within one or more workloads, the policies being specified on a workload basis such that a given policy is specific to a given workload;
formulating an execution plan that denotes reservations of the system resource as specified by the policies; and
dispatching workloads to the system resource based on the execution plan.

18. The method of claim 17, wherein formulating an execution plan comprises including rate based reservations and capacity based reservations in the same execution plan.

19. The method of claim 17, wherein formulating an execution plan comprises including reservations based on policies that are hierarchically related.

20. The method of claim 17, wherein dispatching workloads to the system resource based on the execution plan comprises a dispatcher implemented separate from the policy, such that the dispatcher operates independent of any particular policy, receiving an indication of a workload to be executed by the system resources and the dispatcher selecting the workload and causing the system resources to execute the workload.
